(19) United States
(12) Patent Application Publication
(10) Pub. No.: US 2024/0241599 A1
(43) Pub. Date: Jul. 18, 2024

(54) ELECTRONIC DEVICE, CONTROL METHOD, AND PROGRAM

(71) Applicant: SONY GROUP CORPORATION, TOKYO (JP)

(72) Inventor: KENICHI KASHIWAZAKI, TOKYO (JP)

(21) Appl. No.: 18/559,356

(22) PCT Filed: May 26, 2021
(86) PCT No.: PCT/JP2021/020079

§ 371 Date: Nov. 7, 2023

(51) Int. Cl. G06F 3/041; G06F 3/044

(52) U.S. Cl. CPC G06F 3/041661; G06F 3/044

(57) ABSTRACT

An electronic device (1) according to the present disclosure includes a touch panel (2) and a detection unit. The touch panel (2) detects a touch operation on a screen. The detection unit detects a change in electrostatic capacitance at each position of the touch panel (2). In addition, the detection unit scans the electrostatic capacitance at each position from a start point (SP), the start point (SP) being at a position different from a corner portion (2e) of the touch panel (2).

### FIELD

The present disclosure relates to an electronic device, a control method, and a program.

### BACKGROUND

In the related art, touch panels in which a display device and an input device are combined are used in electronic devices such as smartphones or tablet terminals (see Patent Literature 1).

### CITATION LIST

### Patent Literature

Patent Literature 1: JP H06-342340 A

### SUMMARY

### Technical Problem

The present disclosure proposes an electronic device, a control method, and a program capable of quickly detecting input to a touch panel.

### Solution to Problem

According to the present disclosure, there is provided an electronic device. The electronic device includes a touch panel and a detection unit. The touch panel detects a touch operation on a screen. The detection unit detects a change in electrostatic capacitance at each position of the touch panel. In addition, the detection unit scans the electrostatic capacitance at each position from a start point, the start point being at a position different from a corner portion of the touch panel.

### BRIEF DESCRIPTION OF DRAWINGS

FIG. 1 is a diagram illustrating an exemplary overview of an electronic device according to an embodiment of the present disclosure.

FIG. 2 is a block diagram illustrating an exemplary configuration of the electronic device according to the embodiment of the present disclosure.

FIG. 3 is a diagram for explaining a method of detecting input to a touch panel of a reference example.

FIG. 4 is a diagram for explaining a method of detecting input to a touch panel of the embodiment.

FIG. 5 is a diagram for explaining a method of detecting input to a touch panel according to a first modification of the embodiment.

FIG. 6 is a diagram for explaining a method of detecting input to a touch panel according to a second modification of the embodiment.

FIG. 7 is a diagram for explaining a method of detecting input to a touch panel according to a third modification of the embodiment.

FIG. 8 is a diagram for explaining a method of detecting input to a touch panel according to a fourth modification of the embodiment.

FIG. 9 is a diagram for explaining a method of detecting input to a touch panel according to a fifth modification of the embodiment.

FIG. 10 is a block diagram illustrating another exemplary configuration of an electronic device according to an embodiment of the present disclosure.

### DESCRIPTION OF EMBODIMENTS

Hereinafter, embodiments of the present disclosure will be described in detail on the basis of the drawings. Note that in each of the following embodiments, the same parts are denoted by the same symbols, and redundant description will be omitted.

In the related art, touch panels in which a display device and an input device are combined are used in electronic devices such as smartphones or tablet terminals. In such a touch panel, for example, a touch integrated circuit (IC) detects electrostatic capacitance at each position while scanning at the position and transmits information regarding presence or absence of a change in the electrostatic capacitance and coordinates at which the electrostatic capacitance has changed to a central processing unit (CPU) or the like of the electronic device.

In recent years, there is an increasing demand for technology capable of quickly detecting input to a touch panel in applications such as games. However, in the above-described related art, there is room for further improvement in quickly detecting input to a touch panel.

### Electronic Device

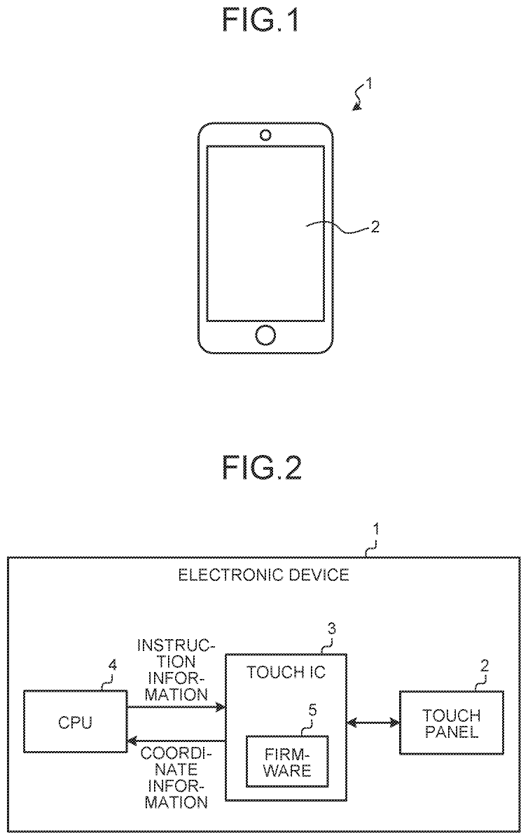

First, an overview of an electronic device 1 according to an embodiment will be described with reference to FIGS. 1 and 2. FIG. 1 is a diagram illustrating an exemplary overview of the electronic device 1 according to the embodiment of the present disclosure.

The electronic device 1 of the embodiment is, for example, a smart device such as a smartphone, a tablet terminal, a personal digital assistant (PDA), or a smart watch and includes a touch panel 2.

The touch panel 2 functions as a display unit that displays an application or the like that can be executed by the electronic device 1 and also functions as an input unit with which a user performs input to the electronic device 1 by a contact operation.

Note that the electronic device 1 of the embodiment is not limited to smart devices and may be various electronic devices on which a touch panel is mounted such as a mobile phone, a portable music device, a personal computer, a game machine, an automatic teller machine (ATM), a vending machine, or a car navigation system.

FIG. 2 is a block diagram illustrating an exemplary configuration of the electronic device 1 according to the embodiment of the present disclosure. As illustrated in FIG. 2, the electronic device 1 includes a touch IC 3 and a CPU 4 in addition to the touch panel 2 described above. The touch IC 3 is an example of a detection unit, and the CPU 4 is an example of an instruction unit.

The touch IC 3 controls the touch panel 2. For example, the touch IC 3 detects a change in electrostatic capacitance at each position of the touch panel 2 by detecting the electrostatic capacitance at each position of the touch panel 2 at predetermined time intervals.

The touch IC 3 further includes firmware 5. The firmware 5 converts a change in the electrostatic capacitance at each position of the touch panel 2 into information regarding coordinates (hereinafter, also referred to as “coordinate information”) at which the electrostatic capacitance has changed in the touch panel 2.

Then, the touch IC 3 transmits the coordinate information to the CPU 4. On the basis of the coordinate information that has been received, the CPU 4 determines whether or not a user has made input to the touch panel 2 by a contact operation, determines a specific input mode by the user, or the like.

### Embodiments

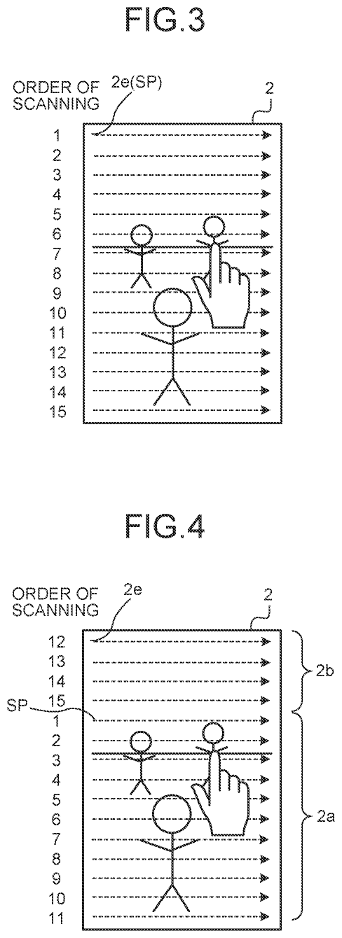

Next, a method for detecting input to the touch panel 2 of the embodiment will be described with reference to FIGS. 3 and 4. FIG. 3 is a diagram for explaining a method of detecting input to the touch panel 2 according to a reference example.

As illustrated in FIG. 3, in this reference example, the touch IC 3 (see FIG. 2) detects the electrostatic capacitance at each position while scanning at each position of the touch panel 2 in a predetermined order. Note that, in the following drawings, the direction of such scanning is indicated by a broken line arrow.

In this reference example, the touch IC 3 scans the electrostatic capacitance along the lateral direction with a predetermined (upper left in the drawing) corner portion 2e of the touch panel 2 as a start point SP. Then, the touch IC 3 scans the electrostatic capacitance from one side (left side in the drawing) to the other side (right side in the drawing) and then repeatedly scans the electrostatic capacitance from one side to the other side while gradually shifting the position along the longitudinal direction.

As a result, the touch IC 3 detects the electrostatic capacitance at each position on the touch panel 2. Furthermore, the touch IC 3 detects a change in the electrostatic capacitance at each position of the touch panel 2 by performing similar scanning for each position at predetermined time intervals.

Incidentally, in various applications that can be executed by the electronic device 1, the entire surface of the touch panel 2 is not always an input target by a contact operation. For example, as illustrated in FIG. 3, in a case where the electronic device 1 is executing a game application and the game application is displayed on the touch panel 2, an upper portion of the screen may not be an input target by the contact operation.

Meanwhile, even in such a case, the electrostatic capacitance is scanned with the corner portion 2e as the start point SP in the reference example, and thus it may take time until the order of scanning reaches the portion where the contact operation is actually performed.

For example, in the example of FIG. 3, the contact operation by a user is performed on a character displayed in the right of the center of the screen, however, the input by the contact operation cannot be detected until the order of scanning reaches the seventh place. Therefore, in the reference example, there is a time difference between the input by the contact operation and detection of the input, and thus the user may feel uncomfortable.

Therefore, in the embodiment, an improvement is made regarding such a defect by setting a portion other than the corner portion 2e as the start point SP of scanning of the electrostatic capacitance. FIG. 4 is a diagram for explaining a method of detecting input to the touch panel 2 of the embodiment.

As illustrated in FIG. 4, in the embodiment, first, the CPU 4 (see FIG. 2) classifies each position of the touch panel 2 into a first region 2a and a second region 2b depending on an application displayed on the touch panel 2.

The first region 2a is a region where it is estimated that a contact operation by a user is frequently performed. Meanwhile, the second region 2b is a region where it is estimated that a contact operation by a user is not frequently performed.

In the embodiment, in a case where the corner portion of the first region 2a is different from the corner portion 2e of the touch panel 2, the CPU 4 sets the corner portion of the first region 2a as the start point SP of scanning of the electrostatic capacitance. Then, the CPU 4 transmits the information regarding the start point SP, which has been set, to the touch IC 3 as instruction information (see FIG. 2).

As described above, in the embodiment, the CPU 4 sets the start point SP of scanning of the electrostatic capacitance depending on an application displayed on the touch panel 2 and instructs the touch IC 3 to set the start point SP. This makes it possible to quickly detect input to the touch panel 2.

For example, as illustrated in FIG. 4, in a case where a contact operation by the user is performed on a character displayed in the right of the center of the screen, input by this contact operation can be detected in the third place of the order of scanning. That is, in the embodiment, the time difference between the input by the contact operation and detection of the input can be shortened as compared with the reference example.

Moreover, in the embodiment, it is preferable that the CPU 4 instructs the touch IC 3 to set a start point SP that has been set on the basis of an application having been displayed on the touch panel 2. As a result, in the embodiment, the optimal start point SP can be set depending on various applications that can be executed by the electronic device 1.

In addition, in the embodiment, the CPU 4 may instruct the touch IC 3 to set the start point SP that has been set on the basis of a use history of the user. For example, in the embodiment, the CPU 4 classifies each position of the touch panel 2 into the first region 2a and the second region 2b on the basis of the use history of the user.

Furthermore, in the embodiment, in a case where the corner portion of the first region 2a is different from the corner portion 2e of the touch panel 2, the CPU 4 may set the corner portion of the first region 2a as the start point SP of scanning of the electrostatic capacitance. As a result, in the embodiment, an optimal start point SP can be set depending on a user who uses the electronic device 1.

In addition, in the embodiment, the CPU 4 may extract feature data indicating the feature of the use history from the use history of the user using a machine learning model and instruct the start point SP of scanning of the electrostatic capacitance on the basis of the feature data. For example, in the embodiment, the CPU 4 classifies each position of the touch panel 2 into the first region 2a and the second region 2b on the basis of the feature data.

Furthermore, in the embodiment, in a case where the corner portion of the first region 2a is different from the corner portion 2e of the touch panel 2, the CPU 4 may set the corner portion of the first region 2a as the start point SP of scanning of the electrostatic capacitance. As a result, in the embodiment, a more optimal start point SP can be set depending on a user who uses the electronic device 1.

Moreover, in the embodiment, the CPU 4 may instruct the touch IC 3 to set a start point SP that has been set on the basis of an application having been displayed on the touch panel 2 and a use history of a user.

As a result, in the embodiment, the optimal start point SP can be set depending on various applications that can be executed by the electronic device 1 and a user who uses the electronic device 1.

### [Various Modifications]

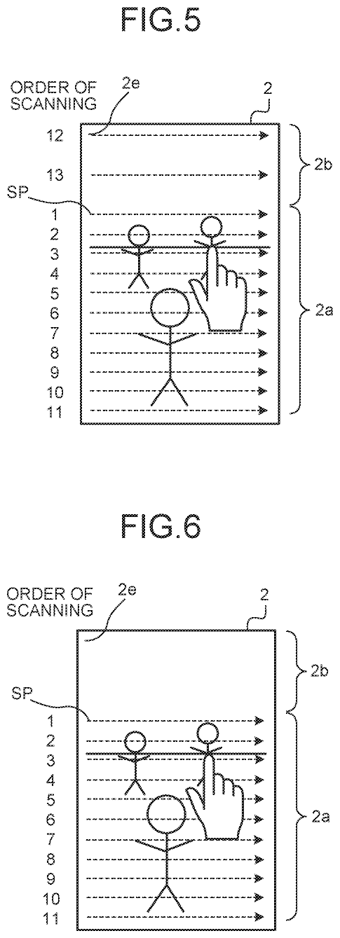

Next, various modifications of the embodiment will be described with reference to FIGS. 5 to 10. FIG. 5 is a diagram for explaining a method of detecting input to the touch panel 2 according to a first modification of the embodiment.

As illustrated in FIG. 5, in the first modification, the CPU 4 (see FIG. 2) may instruct the touch IC 3 (see FIG. 2) to perform scanning of the electrostatic capacitance in the second region 2b less than the scanning of the electrostatic capacitance in the first region 2a.

As a result, since input to the touch panel 2 can be detected with low power, the electronic device 1 can be made power-saving.

FIG. 6 is a diagram for explaining a method of detecting input to the touch panel 2 according to a second modification of the embodiment. As illustrated in FIG. 6, in the second modification, the CPU 4 (see FIG. 2) may instruct the touch IC 3 (see FIG. 2) not to scan the electrostatic capacitance in the second region 2b.

As a result, since input to the touch panel 2 can be detected with even less power, the electronic device 1 can be made more power-saving.

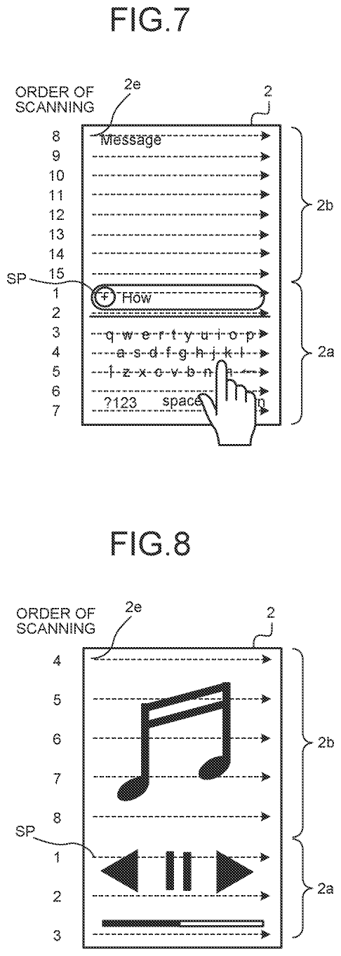

FIG. 7 is a diagram for explaining a method of detecting input to the touch panel 2 according to a third modification of the embodiment. In the embodiment and the first and second modifications described above, the case where the electronic device 1 displays the game application has been described, however, the application to which the technology of the present disclosure is applied is not limited to game applications.

For example, as illustrated in FIG. 7, the technology of the present disclosure may be applied to a case where the electronic device 1 displays an application that transmits and receives messages.

As described above, when the electronic device 1 is executing a message application and the message application is displayed on the touch panel 2, a user interface for character input is displayed on a part of the screen (for example, at a lower portion of the screen). Meanwhile, a portion other than the user interface (for example, an upper part of the screen) may not be an input target by touch operations.

In such a case, in the third modification, the CPU 4 classifies the portion where the user interface is displayed into the first region 2a and classifies the other portion into the second region 2b.

In the third embodiment, in a case where the corner portion of the first region 2a is different from the corner portion 2e of the touch panel 2, the CPU 4 sets the corner portion of the first region 2a as the start point SP of scanning of the electrostatic capacitance.

Then, the CPU 4 transmits the information regarding the start point SP, which has been set, to the touch IC 3 as instruction information (see FIG. 2). This makes it possible to quickly detect input to the touch panel 2.

FIG. 8 is a diagram for explaining a method of detecting input to the touch panel 2 according to a fourth modification of the embodiment. In the electronic device 1, there are cases where input by a contact operation is not frequently performed. For example, as illustrated in FIG. 8, in an application for playing music, input by a touch operation on the touch panel 2 may not be frequently performed.

Therefore, in a case where input by a touch operation has not been performed for a certain period of time (for example, for about one second) or more, there are cases where the CPU 4 (see FIG. 2) instructs the touch IC 3 (see FIG. 2) to shift to a power saving mode in which scanning of the electrostatic capacitance at each position of the touch panel 2 is performed less.

As a result, since input to the touch panel 2 can be detected with low power, the electronic device 1 can be made power-saving.

Incidentally, in the fourth modification, in a case where input to the touch panel 2 is detected in the power saving mode, the CPU 4 may set the start point SP of scanning of the electrostatic capacitance depending on an application displayed on the touch panel 2 and instruct the touch IC 3 to set the start point SP.

For example, as illustrated in FIG. 8, in a case where the electronic device 1 is executing an application for playing music and the application for playing music is displayed on the touch panel 2, there are cases where the central portion and an upper portion of the screen are not an input target by a contact operation.

In such a case, in the fourth modification, the CPU 4 classifies each position of the touch panel 2 into the first region 2a and the second region 2b depending on an application displayed on the touch panel 2.

In the fourth embodiment, in a case where the corner portion of the first region 2a is different from the corner portion 2e of the touch panel 2, the CPU 4 sets the corner portion of the first region 2a as the start point SP of scanning of the electrostatic capacitance. Then, the CPU 4 transmits the information regarding the start point SP, which has been set, to the touch IC 3 as instruction information (see FIG. 2).

As a result, even in a case where input to the touch panel 2 is detected in the power saving mode, input to the touch panel 2 can be quickly detected.

Note that, in the fourth modification, only the presence or absence of input to the touch panel 2 may be detected in the power saving mode, and when there is input to the touch panel 2, the CPU 4 may instruct the touch IC 3 to immediately shift to the normal mode in which scanning is not reduced.

In this case, only the input to the touch panel 2 is detected in the power saving mode, and detection of the coordinates at which the input to the touch panel 2 has been made (namely, the electrostatic capacitance has changed) is performed in the normal mode after the shift.

This makes it possible to detect more accurate input coordinates as compared with the case of detecting coordinates at which input to the touch panel 2 has been performed in the power saving mode.

Moreover, in the fourth modification, even when there has been a shift from the power saving mode to the normal mode, it is preferable to set the corner portion of the first region 2a as the start point SP of scanning of the electrostatic capacitance. As a result, when the mode shifts to the normal mode, the input position to the touch panel 2 can be quickly detected.

Furthermore, in the fourth modification, even when there has been a shift from the normal mode to the power saving mode, it is preferable to set the corner portion of the first region 2a as the start point SP of scanning of the electrostatic capacitance. As a result, it is possible to quickly detect that there has been input to the touch panel 2 upon shift to the power saving mode.

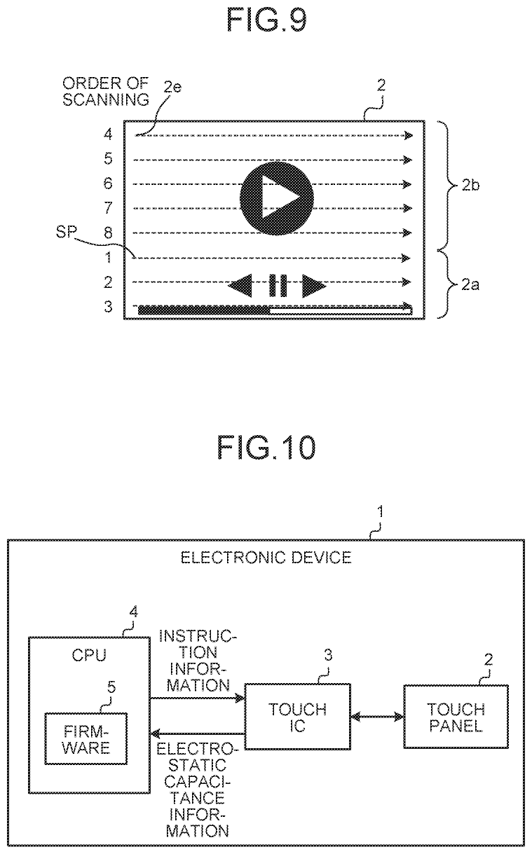

FIG. 9 is a diagram for explaining a method of detecting input to the touch panel 2 according to a fifth modification of the embodiment. In the electronic device 1, there are cases where an operation is performed by changing the orientation to the lateral direction. For example, as illustrated in FIG. 9, an application for reproducing a moving image may be operated by changing the orientation of the electronic device 1 to the lateral orientation.

Here, in the fifth modification, in the case of operating the electronic device 1 by changing the orientation of the electronic device 1, the CPU 4 (see FIG. 2) may instruct the touch IC 3 to change the direction of scanning depending on the orientation of the electronic device 1 as illustrated in FIG. 9.

For example, when the electronic device 1 is in the lateral direction, the CPU 4 may instruct the touch IC 3 to scan the electrostatic capacitance along the longitudinal direction of the touch panel 2 and to repeatedly scan from one side to the other side while gradually shifting the position along the lateral direction. This makes it possible to quickly detect input to the touch panel 2.

In addition, in the fifth modification, similarly to the above embodiment and various modifications, the CPU 4 may set the start point SP of scanning of the electrostatic capacitance depending on an application displayed on the touch panel 2 and instruct the touch IC 3 to set the start point SP.

For example, as illustrated in FIG. 9, in a case where the electronic device 1 is executing an application for reproducing moving images and the application for reproducing moving images is displayed on the touch panel 2, there are cases where the central portion and an upper portion of the screen are not an input target by a contact operation.

In such a case, in the fifth modification, the CPU 4 classifies each position of the touch panel 2 into the first region 2a and the second region 2b depending on an application displayed on the touch panel 2.

In the fifth embodiment, in a case where the corner portion of the first region 2a is different from the corner portion 2e of the touch panel 2, the CPU 4 sets the corner portion of the first region 2a as the start point SP of scanning of the electrostatic capacitance. Then, the CPU 4 transmits the information regarding the start point SP, which has been set, to the touch IC 3 as instruction information (see FIG. 2).

As a result, even in the case where the direction of scanning is changed depending on the orientation of the electronic device 1, input to the touch panel 2 can be quickly detected.

Note that the orientation of the electronic device 1 can be determined by the CPU 4 on the basis of, for example, a value measured by an acceleration sensor mounted on the electronic device 1.

FIG. 10 is a block diagram illustrating another exemplary configuration of an electronic device 1 according to an embodiment of the present disclosure. As illustrated in FIG. 10, in the electronic device 1, a CPU 4 may include firmware 5 that converts a change in electrostatic capacitance at each position of a touch panel 2 into coordinate information.

In this case, a touch IC 3 transmits information (hereinafter, also referred to as “electrostatic capacitance information”) related to the electrostatic capacitance at each position of the touch panel 2 to the firmware 5 of the CPU 4. Then, the firmware 5 converts the electrostatic capacitance information into coordinate information.

Even with such a configuration, on the basis of instruction information from the CPU 4, the touch IC 3 can quickly detect input to the touch panel 2 by setting a portion other than a corner portion 2e as a start point SP of scanning of the electrostatic capacitance.

Note that, in the present disclosure, the configuration of the electronic device 1 is not limited to the example of FIG. 2 or the example of FIG. 10, and for example, the function of the touch IC 3 may be integrated into the CPU 4.

### Effects

The electronic device 1 according to the embodiment includes the touch panel 2 and a detection unit (touch IC 3). The touch panel 2 detects a touch operation on a screen. The detection unit (touch IC 3) detects a change in the electrostatic capacitance at each position of the touch panel 2. In addition, the detection unit (touch IC 3) scans the electrostatic capacitance at each position from the start point SP, the start point SP being at a position different from the corner portion 2e of the touch panel 2.

This makes it possible to quickly detect input to the touch panel 2.

In addition, the electronic device 1 of the embodiment further includes the instruction unit (CPU 4) that instructs, to the detection unit (touch IC 3), the start point SP of scanning of the electrostatic capacitance.

As a result, the touch IC 3 can scan the electrostatic capacitance at each position from a more appropriate start point SP.

Moreover, in the electronic device 1 of the embodiment, the instruction unit (CPU 4) instructs the start point SP of scanning of the electrostatic capacitance on the basis of the application displayed on the screen.

As a result, an optimal start point SP can be set depending on various applications that can be executed by the electronic device 1.

Furthermore, in the electronic device 1 of the embodiment, the instruction unit (CPU 4) instructs the start point SP of scanning of the electrostatic capacitance on the basis of the use history of the user.

As a result, an optimal start point SP can be set depending on a user who uses the electronic device 1.

In addition, in the electronic device 1 of the embodiment, the instruction unit (CPU 4) extracts feature data indicating the feature of the use history from the use history of the user using a machine learning model and instructs the start point SP of scanning of the electrostatic capacitance on the basis of the feature data.

As a result, a more optimal start point SP can be set depending on a user who uses the electronic device 1.

Furthermore, in the electronic device 1 of the embodiment, the instruction unit (CPU 4) instructs the detection unit (touch IC 3) to perform scanning of the electrostatic capacitance of the region (second region 2b), in which it is determined that input by a contact operation is not frequently performed, less than that of the region (first region 2a) in which it is determined that input by a contact operation is frequently performed.

As a result, since input to the touch panel 2 can be detected with low power, the electronic device 1 can be made power-saving.

In addition, in the electronic device 1 of the embodiment, the instruction unit (CPU 4) instructs the detection unit (touch IC 3) not to scan the electrostatic capacitance of the region (second region 2b) in which it is determined that input by a contact operation is not frequently performed.

As a result, since input to the touch panel 2 can be detected with even less power, the electronic device 1 can be made more power-saving.

Furthermore, in the electronic device 1 of the embodiment, the instruction unit (CPU 4) instructs the detection unit (touch IC 3) to change the direction of scanning depending on the orientation of the electronic device 1.

This makes it possible to quickly detect input to the touch panel 2.

Meanwhile, a control method according to the embodiment includes a detection step in which the processor (touch IC 3) detects a change in electrostatic capacitance at each position of the touch panel 2 that detects a touch operation on the screen. Note that, in the detection step, scanning of the electrostatic capacitance at each position is performed from the start point SP, the start point SP being at a position different from the corner portion 2e of the touch panel 2.

This makes it possible to quickly detect input to the touch panel 2.

In addition, a program according to the embodiment causes a computer (touch IC 3) to function as a detection unit that detects a change in electrostatic capacitance at each position of the touch panel 2 that detects a touch operation on the screen. In addition, the detection unit scans the electrostatic capacitance at each position from the start point SP, the start point SP being at a position different from the corner portion 2e of the touch panel 2.

This makes it possible to quickly detect input to the touch panel 2.

Although the embodiments of the disclosure have been described above, the technical scope of the disclosure is not limited to the above embodiments as they are, and various modifications can be made without departing from the gist of the disclosure. In addition, components of different embodiments and modifications may be combined as appropriate.

For example, in the above embodiment, the example in which the corner portion of the first region 2a is set as the start point SP has been described, however, the start point SP is not limited to the corner portion of the first region 2a, and any position of the first region 2a may be set as long as the position is different from the corner portion 2e of the touch panel 2.

In addition, in the above embodiment, the example has been described in which each position of the touch panel 2 is classified into two types of regions (first region 2a and second region 2b) depending on an estimated frequency of a contact operation by a user, however, the number of types of such classification is not limited to two.

For example, the CPU 4 may instruct the touch IC 3 to classify each position of the touch panel 2 into three or more types depending on an estimated frequency of a contact operation by a user and to scan the electrostatic capacitance of the regions in the descending order of the estimated frequency. As a result, input to the touch panel 2 can be detected more quickly.

Furthermore, the effects described herein are merely examples and are not limiting, and other effects may be achieved.

Note that the present technology can also have the following configurations.

(1)

An electronic device comprising:
a touch panel that detects a touch operation on a screen; and
a detection unit that detects a change in electrostatic capacitance at each position of the touch panel,
wherein the detection unit scans the electrostatic capacitance at each position from a start point, the start point being at a position different from a corner portion of the touch panel.

(2) The electronic device according to the above (1), further comprising:
an instruction unit that instructs, to the detection unit, the start point of scanning of the electrostatic capacitance.
   (3)

The electronic device according to the above (2),
wherein the instruction unit instructs the start point of scanning of the electrostatic capacitance on a basis of an application displayed on the screen.
   (4)

The electronic device according to the above (2) or (3),
wherein the instruction unit instructs the start point of scanning of the electrostatic capacitance on a basis of a use history of a user.
   (5)

The electronic device according to the above (4),
wherein the instruction unit extracts feature data indicating a feature of the use history from the use history of the user using a machine learning model and instructs the start point of scanning of the electrostatic capacitance on a basis of the feature data.
   (6)

The electronic device according to any one of the above (2) to (5),
wherein the instruction unit instructs the detection unit to scan the electrostatic capacitance of a region, in which it is determined that input by a contact operation is not frequently performed, less than scanning of the electrostatic capacitance in a region in which it is determined that input by a contact operation is frequently performed.
   (7)

The electronic device according to any one of the above (2) to (5),
wherein the instruction unit instructs the detection unit not to scan the electrostatic capacitance of the region in which it is determined that input by a contact operation is not frequently performed.
   (8)

The electronic device according to any one of the above (2) to (7),
wherein the instruction unit instructs the detection unit to change a direction of scanning depending on an orientation of the electronic device.
   (9)

A control method comprising:
a detection step of, by a processor, detecting a change in electrostatic capacitance at each position of a touch panel, the touch panel for detecting a touch operation on a screen, wherein the detection step performs scanning of the electrostatic capacitance at each position from a start point, the start point being at a position different from a corner portion of the touch panel.
   (10)

The control method according to the above (9), further including:
an instruction step of instructing, to the detection step, the start point of scanning of the electrostatic capacitance.
   (11)

The control method according to the above (10),
in which the instruction step unit instructs the start point of scanning of the electrostatic capacitance on the basis of an application displayed on the screen.
   (12)

The control method according to the above (10) or (11),
in which, in the instruction step, the start point of scanning of the electrostatic capacitance is instructed on the basis of a use history of a user.
   (13)

The control method according to the above (12),
in which, in the instruction step,
feature data indicating a feature of the use history is extracted from the use history of the user using a machine learning model, and
the start point of scanning of the electrostatic capacitance is instructed on a basis of the feature data.
   (14)

The control method according to any one of the above (10) to (13),
in which, in the instruction step, it is instructed to the detection step to scan the electrostatic capacitance of a region, in which it is determined that input by a contact operation is not frequently performed, less than scanning of the electrostatic capacitance in a region in which it is determined that input by a contact operation is frequently performed.
   (15)

The control method according to any one of the above (10) to (13),
in which, in the instruction step, it is instructed to the detection step not to scan the electrostatic capacitance of the region in which it is determined that input by a contact operation is not frequently performed.
   (16)

The control method according to any one of the above (10) to (15),
in which, in the instruction step, it is instructed to the detection step to change a direction of scanning depending on an orientation of the electronic device.
   (17)

A program for causing a computer to function as:
a detection unit that detects a change in electrostatic capacitance at each position of a touch panel, the touch panel for detecting a touch operation on a screen,
wherein the detection unit performs scanning of the electrostatic capacitance at each position from a start point, the start point being at a position different from a corner portion of the touch panel.
   (18)

The program according to the above (17) for causing the computer to further function as:
an instruction unit that instructs, to the detection unit, the start point of scanning of the electrostatic capacitance.
   (19)

The program according to the above (18),
in which the instruction unit instructs the start point of scanning of the electrostatic capacitance on the basis of an application displayed on the screen.
   (20)

The program according to the above (18) or (19),
in which the instruction unit instructs the start point of scanning of the electrostatic capacitance on the basis of a use history of a user.
   (21)

The program according to the above (20),
in which the instruction unit extracts feature data indicating a feature of the use history from the use history of the user using a machine learning model and instructs the start point of scanning of the electrostatic capacitance on the basis of the feature data.
   (22)

The program according to any one of the above (18) to (21),
in which the instruction unit instructs the detection unit to scan the electrostatic capacitance of a region, in which it is determined that input by a contact operation is not frequently performed, less than scanning of the electrostatic capacitance in a region in which it is determined that input by a contact operation is frequently performed.
   (23)

The program according to any one of the above (18) to (21),
in which the instruction unit instructs the detection unit not to scan the electrostatic capacitance of the region in which it is determined that input by a contact operation is not frequently performed.
   (24)

The program according to any one of the above (18) to (23),
in which the instruction unit instructs the detection unit to change a direction of scanning depending on an orientation of the electronic device.

### REFERENCE SIGNS LIST

1 ELECTRONIC DEVICE
2 TOUCH PANEL
2a FIRST REGION
2b SECOND REGION
2e CORNER PORTION
3 TOUCH IC (EXAMPLE OF DETECTION UNIT)
4 CPU (EXAMPLE OF INSTRUCTION UNIT)
5 FIRMWARE
SP START POINT

1. An electronic device comprising:
a touch panel that detects a touch operation on a screen; and
a detection unit that detects a change in electrostatic capacitance at each position of the touch panel,
wherein the detection unit scans the electrostatic capacitance at each position from a start point, the start point being at a position different from a corner portion of the touch panel.

2. The electronic device according to claim 1, further comprising:
an instruction unit that instructs, to the detection unit, the start point of scanning of the electrostatic capacitance.

3. The electronic device according to claim 2,
wherein the instruction unit instructs the start point of scanning of the electrostatic capacitance on a basis of an application displayed on the screen.

4. The electronic device according to claim 2,
wherein the instruction unit instructs the start point of scanning of the electrostatic capacitance on a basis of a use history of a user.

5. The electronic device according to claim 4,
wherein the instruction unit extracts feature data indicating a feature of the use history from the use history of the user using a machine learning model and instructs the start point of scanning of the electrostatic capacitance on a basis of the feature data.

6. The electronic device according to claim 2,
wherein the instruction unit instructs the detection unit to scan the electrostatic capacitance of a region, in which it is determined that input by a contact operation is not frequently performed, less than scanning of the electrostatic capacitance in a region in which it is determined that input by a contact operation is frequently performed.

7. The electronic device according to claim 2,
wherein the instruction unit instructs the detection unit not to scan the electrostatic capacitance of the region in which it is determined that input by a contact operation is not frequently performed.

8. The electronic device according to claim 2,
wherein the instruction unit instructs the detection unit to change a direction of scanning depending on an orientation of the electronic device.

9. A control method comprising:
a detection step of, by a processor, detecting a change in electrostatic capacitance at each position of a touch panel, the touch panel for detecting a touch operation on a screen,
wherein the detection step performs scanning of the electrostatic capacitance at each position from a start point, the start point being at a position different from a corner portion of the touch panel.

10. A program for causing a computer to function as:
a detection unit that detects a change in electrostatic capacitance at each position of a touch panel, the touch panel for detecting a touch operation on a screen,
wherein the detection unit performs scanning of the electrostatic capacitance at each position from a start point, the start point being at a position different from a corner portion of the touch panel.
